(19) United States
(12) Patent Application Publication
(10) Pub. No.: US 2026/0177215 A1
(43) Pub. Date: Jun. 25, 2026

(54) RECESSED ANTI-GLARE LED SPOTLIGHTS WITH IMPROVED FEATURES

(71) Applicants: John Luk, Flushing, NY (US); Joel Gross, Brooklyn, NY (US); Jingbo Chen, Oakland Gardens, NY (US)

(72) Inventors: John Luk, Flushing, NY (US); Joel Gross, Brooklyn, NY (US); Jingbo Chen, Oakland Gardens, NY (US)

(73) Assignee: Lighting & Supplies, Inc., Brooklyn, NY (US)

(21) Appl. No.: 18/990,626

(22) Filed: Dec. 20, 2024

(51) Int. Cl. F21S 8/02; F21K 9/233; F21K 9/238; F21V 9/40; F21V 19/00; F21V 23/06; F21Y 115/10

(52) U.S. Cl. CPC F21S 8/026; F21K 9/233; F21K 9/238; F21V 9/40; F21V 19/004; F21V 23/06; F21Y 2115/10

(57) ABSTRACT

The present invention is directed to a recessed anti-glare LED spotlight fixture with improved features including a remote junction box and LED driver assembly for the flexible installation of the improved recessed anti-glare LED spotlight fixture. Additional features and improvements include a plurality of spring retaining assemblies for the insertion and removal of the LED light engine module in and out from a receiving surface that is supported and held by a receiving frame, and an integral hardware switch provided on the LED light engine module to preset the color temperature of the light source. The receiving frame can accommodate at least one LED light engine module and can be a trimless spackle mud frame or a flanged trim frame. Interchangeable round and square baffle trims, changeable beam angle reflector and LED optics, and a protective barrier lens are preferably incorporated. The same LED light engine module can be used for both trimless or flangeless trim and trimmed or flanged trim installations. The improved recessed anti-glare LED spotlight fixture can be used in both new construction and retrofit remodel installations sharing similar parts to provide ease of installation and maintenance.

### FIELD OF THE INVENTION

The present invention relates to a recessed anti-glare LED spotlight fixture with improved features and benefits that is configurable for both new construction installations and retrofit remodel installations in residential and commercial applications.

### BACKGROUND OF THE INVENTION

Incandescent tungsten filament lamps were the first source of light that was created. These incandescent lamps were later used on dimmers that controlled the amount of current going into the lamps to provide dimming of the light output and for energy savings. HID (High Intensity Discharge) or MH (Metal Halide lamps) and fluorescent lamps were later discovered that offered increased lamp life and brighter outputs over the incandescent lamps. These HID or fluorescent lamps operated with a ballast that first ignited an arc and then limited the power to the lamp to keep the arc operating. Certain HID or fluorescent lamps could be used with special dimming ballasts that could be dimmed for additional energy savings.

Advancements in LED brightness and efficacy have allowed LED lamps and LED fixtures to be developed that could offer even longer lamp life and brighter light outputs when properly configured, to compete with HID or fluorescent lamps. An LED driver is used to provide the correct power to the LEDs either through PWM (Pulse Width Modulation), constant voltage, or constant current. The LED lamps and LED fixtures can be hard-wired directly to the driver in an internal or external configuration, or the driver can be eliminated with the use of dimmable AC Driver-On-Board or AC DOB LED light fixtures using IC driver controller chips. The LED drivers can be made dimmable for use with the already inherent energy savings nature provided by the LEDs for added energy savings.

For modern designs and ease of retrofits, it is desirable to have one LED light or LED fixture that can be installed into existing incandescent, compact fluorescent, or HID fixtures to create a longer lasting and energy efficient LED luminaire. The present invention provides for an LED light or LED fixture that allows an end user to have a retrofit LED lamp option to existing halogen, compact fluorescent, or HID luminaires. The same invention also provides an LED light or LED fixture option that allows an end user to readily install a new LED light or LED fixture as a recessed ceiling down light, or as a recessed wall light in new installations.

LED recessed spotlights are widely available from many manufacturers in popular sizes including 1″, 2″, 3″, 4″, 5″, 6″, 8″, and 10″ diameters for use in both commercial and resident installations. Typically, a different fixture is offered for either new construction installations or retrofit remodel installations in the many sizes but may share similar trims and the same LED light engine module. There becomes a first need for one spotlight fixture that can be easily adapted to work in a new construction application or in a retrofit remodel application by sharing similar structural components with minimal additional parts for the installation needed.

The present invention will provide for a more versatile and simpler method to install the same recessed anti-glare LED spotlight fixture in multiple applications including new construction and retrofit remodel LED recessed spotlight fixture installations in a ceiling or behind a wall. For new construction installations, a properly sized hole is drilled in the ceiling or wall and a receiving support frame is installed into the hole from which a remote junction box containing an internal LED driver attached to an LED light engine module via a flexible power supply cord, which is inserted into and held by the receiving support frame. For a retrofit remodel installation, the existing lighting can is removed and discarded leaving the existing hole intact in the ceiling or wall. Next, the same receiving support frame is installed into the existing hole from which a remote junction box containing an internal LED driver attached to an LED light engine module via a flexible power supply cord, which is inserted into and held by the receiving support frame that is in turn securely attached to the ceiling or wall for a secure and reliable hold.

The use of a plurality of spring retention mechanism assemblies including at least three dual-action push-in-to-lock and push-in-to-unlock spring retention mechanism assemblies to hold and secure the entire LED light engine module; a color tuning switch provided on the LED light engine module offering three correlated color temperatures (3CCT) or five correlated color temperatures (5CCT); a remote receiving support frame or flanged trim support frame with a pair of integral surface snap-action spring clips for the LED light engine module; a flexible pair of removable and connectable power supply cables between the LED light engine module and LED driver located in the remote junction box assembly; interchangeable locking round and square trims; changeable reflector and optional LED optics; and a protective barrier front lens will all offer the end-user better flexibility for quicker installation and maintenance of the LED spotlight fixture in operation for the life of the light fixture.

### DESCRIPTION OF THE RELATED ART

Schneider Electric USA, Inc. discloses an LED recessed light that can be used in existing ceiling fixture cans as a retrofit in U.S. Pat. No. 8,142,057 issued on Mar. 27, 2012, to Roos et al. titled, “Recessed LED Downlight”. Their invention includes a unitary die-cast cap for a downlight with a base section with a plurality of heat-sink fins on the exterior wall surface. The downlight assembly includes an interior plate, a plurality of spring retainers mounted to the interior plate, LEDs, a reflector, and lens assembly mounted to the interior plate and die-cast cap, and a finishing trim mounted to the spring retainers by way of a plurality of coil springs. The drawback of this invention is it is only to be used on an existing lighting can for retrofit applications only. It is primarily for ceiling installations only and not for wall mounting. The present invention offers an improved feature than this disclosed downlight assembly, because it is more versatile for use with and without a lighting can in both new construction and retrofit remodel installations in both ceilings and walls depending on the application.

U.S. Pat. No. 11,378,264 issued on Jul. 5, 2022, to Huang et al. titled, “Downlight Apparatus” is assigned to Xiamen Eco Lighting Co., Ltd. located in Xiamen, China. This invention includes a light source module, a cup housing including a surface rim and cup body, multiple LED emitters disposed in the cup housing, and a rotation structure including a first and second exterior diameter trim rings. The LED driver is internally located above the LED and cup housing, and there is a switch provided on the LED driver to adjust the light output color temperature. The downlight apparatus is used primarily for retrofit applications with a plug-in pigtail wire terminating in a male medium screw base E26 socket adapter to provide AC power to the downlight apparatus. As before, the present invention offers an improved feature than this disclosed downlight apparatus, because it is more versatile for use with and without a lighting can in both new construction and retrofit remodel installations in both ceilings and walls depending on the application. In addition, the LED driver is remotely located inside a junction box that can be easily replaced and maintained and will not be affected by the thermal heat radiating out from the finned heat sink of the LED light engine. In these types of retrofit downlights, the internal LED drivers are typically OEM devices that are integrated inside the lamp housing body. When they fail, the entire LED downlight apparatus is usually discarded, because the internal LED drivers are typically not removable and cannot be serviced.

Lighting & Supplies, Inc. located in Brooklyn, New York discloses an “LED Downlight with Enhanced Features” in U.S. Pat. No. 11,473,764 issued on Oct. 18, 2022, to Luk et al. This patent discloses an LED downlight that features metal brackets, hinges, and retractable extension arms for the articulation of the attached junction box and LED driver assembly for easier insertion and removal of the LED light engine and junction box assembly for repair or maintenance of the LED driver. The LED downlight includes a horizontal pan and vertical tilt of the LED light engine for focusing the projected light beam onto various surfaces. The easy removal of a pair of special hangar bar mechanisms and mounting brackets easily converts the new construction downlight to a retrofit remodel downlight. An AT or Air-Tight housing is optional for the LED downlight. In contrast, the present invention eliminates the added cost and need for the metal brackets, hinges, and retractable extension arms. A flexible low-voltage power supply cord is provided in the new recessed anti-glare LED spotlight fixture of the present invention, which allows for the placement of the junction box and LED driver assembly to be located in any convenient location above the ceiling or behind a wall for any repairs or maintenance of the LED light engine module or the LED driver. In addition, the use of a non-moving fixed focus with optional and changeable LED optics including the use of directional films and interchangeable reflectors to achieve different projected beam spread angles help to further reduce the overall cost of the LED spotlight fixture of the present invention.

Alcon Lighting offers a recessed light fixture that uses a decorative trim fitting to insert and remove the LED light engine using a pair of push-to-lock and push-to-unlock mechanisms for attachment to a mud plate. However, the color selection switch is located on the internal LED driver installed in their junction box that is remotely positioned away from the light fixture. Having the color selection switch located on the LED driver becomes an issue if the LED driver should fail. A suitably rated LED driver with the selection switch on LED driver will need to be used for repairs or replacements. Therefore, only the original LED drivers with a built-in color temperature switch can be used for replacement and repair making it more difficult and more expensive to maintain and repair for the end user. In addition, the use of only two spring mechanisms will often cause the LED light engine and decorative trim fitting to get jammed with the sides of the mud plate when the LED light engine and decorative trim fitting is not properly engaged and disengaged exactly straight into the mud plate. The present invention uses (3) locking spring mechanism assemblies arranged 120-degrees apart for better compliance offering easier operation of the recessed anti-glare LED spotlight fixtures of the present invention. An alternate design may use (4) such locking spring mechanism assemblies arranged at 90-degrees from each other and even (6) such locking spring mechanism assemblies arranged at 60-degrees from each other for even better compliance and stability during insertion and removal of the LED light engine module.

Maximma Lighting offers a recessed light fixture with SCT Selectable Color Tuning and a remote junction box and driver. An SCT switch is located behind the LED light engine, but the LED light engine is horizontally engaged using a twist-lock motion to lock and unlock it from the trim. This becomes an issue for flush trim less or flangeless trim downlights because it becomes difficult to easily grab the edge of the trim body to horizontally engage and disengage the LED light engine. Using fingers on the front lens would also allow dirt and oil to be applied to the lens, thereby reducing light output, and throwing shadows or obstruction in the projected light beam. The present invention features a vertical push-in and push-out motion on the inside trim surface without touching the front lens to easily engage and disengage the LED light engine module assembly from the receiving frame installed in a ceiling receiving surface, thereby offering greater flexibility and benefit for the end user.

As can be seen, the present invention is a definite improvement over the other inventions. The present invention overcomes all the above issues and problems with existing spotlight fixtures by providing many improved features in the design and installation methods in a family of improved spotlight fixtures. The various embodiments of the present inventions will offer all these advantages and improvements over existing recessed spotlight fixtures that are presently out in the market today.

The present invention for an improved recessed anti-glare LED spotlight fixture with improved features include:
a. a first regressed anti-glare flangeless round or square trim,
b. a trim locking retention ring with mounting screws,
c. a protective barrier front lens,
d. an interchangeable reflector or changeable LED optics,
e. a COB LED holder with mounting screws,
f. a changeable COB LED emitter,
g. two pairs of LED wires or (4) wires in total,
h. a color selection switch and PCBA with mounting screws,
i. a unitary finned heat sink structure with at least (3) recessed cavities,
j. a plurality of spring retaining assemblies including at least (3) separate and identical spring retaining assemblies installed in the at least (3) recessed cavities,
k. a spring retaining assemblies hold down securement ring,
l. a rear plate with a switch access cutout opening with mounting screws,
m. a flexible low-voltage power supply cable with strain relief and male connector,
n. a receiving frame for the corresponding first regressed round or square flangeless baffle trim being used, wherein the receiving frame can be an optional second flanged trim with a pair of surface snap-action spring clips,
o. an LED driver installed in a remote junction box, and
p. a mating flexible low-voltage power supply cable with strain relief and female connector exiting said LED driver installed in a remote junction box.

The LED light engine module engages into and disengages from a fixed external receiving support frame during the installation and maintenance of the recessed anti-glare LED spotlight fixture. The recessed anti-glare LED spotlight fixture of the present invention uses a plurality of spring retaining assemblies including at least (3) spring retaining assemblies that are safer and easier to operate compared to the conventional compression and torsion springs used by the majority of other LED downlights that may be very difficult to handle or the conventional sheet metal springs may have sharp edges that are unsafe and dangerous to handle and work with by an end-user requiring cumbersome and thick work clothes and other personal protection equipment.

Smaller 2″, 3″, and 4″ diameter LED light engine spotlights of the present invention can be made available with narrow and compact sized remote junction boxes with LED drivers that will allow for the entire recessed spotlight assembly to be easily pulled out from the receiving support frame through a ceiling or wall hole cutout in order to change out the LED driver if necessary. This maintenance repair procedure is accomplished by first removing the LED light engine module away from the receiving frame, and second by gently pulling the flexible power supply cord connected to the remote junction box through the ceiling or wall hole for access to the inside LED driver for replacement. When done, the entire junction box assembly is put back into the hole, and the flexible power supply cable and the LED light engine module is installed back into and held securely by the receiving support frame.

Lastly, existing recessed downlights are designed to fit into specific ceiling thicknesses. When the ceiling is too thick or the light engine is recessed too far behind the hole, the existing trims and spring clips provided on the downlights do not properly engage the ceiling or wall from the inside and can cause the existing trims to hang loose or even separate from the ceiling surface causing light leak and improper installations. To account for this, the improved recessed anti-glare LED spotlight fixture of the present invention eliminates this restriction and is designed to work with a wide range of different ceiling thicknesses. This is accomplished with the use of a receiving frame that will fit into any ceiling or wall thickness by mounting only to the outer surface of the ceiling or wall and providing a recessed portion with the correct depth in which to install the LED light engine module into the receiving support frame that is securely held by the plurality of spring retaining assemblies that hold the LED light engine module to the receiving support frame when properly installed together in a ceiling or wall. The round or square trims of the improved recessed spotlight lay flat to the outer surface of the ceiling or wall for a tight seal and present no light leaks at any time.

### SUMMARY OF THE INVENTION

The new recessed anti-glare LED spotlight fixtures of the present invention can incorporate interchangeable trimless or flangeless round trims, trimless or flangeless square trims, flanged round trims, and flanged square trims in the same spotlight. In addition, special metal frame support plates with and without the use of hangar mounting bars can be used with the improved LED spotlight fixture fixtures for added support to the top of the ceiling or behind the wall mounting and receiving surface if needed.

In a first embodiment of the present invention, an improved LED spotlight fixture 10 is disclosed for use in new construction and retrofit remodel installations that can utilize a trimless or flangeless round trim. Installation of the LED spotlight fixture in this embodiment is from above the horizontal or sloped ceiling, but it can also be easily installed into a vertical wall. Installation of the LED spotlight fixture in this preferred first embodiment is from above the ceiling for a new construction application.

The initial step in the installation is to drill a properly sized hole in the ceiling to accommodate the sized spotlight fixture being installed. Once the hole is made, a receiving support frame is installed in the hole from below and secured to the ceiling using screws or other attachment means. An optional backing metal support plate may or may not be used above the ceiling. Next, a source of high voltage input AC power is brought to the LED spotlight fixture using either a 3-conductor BX metal armor jacketed cable for New York City use, or a 3-conductor flat Romex cable from above the ceiling and out the receiving surface hole for connection to the LED driver located inside the junction box. Once the LED driver is connected and the respective high voltage input AC power supply cable is secured to the junction box, the entire junction box and LED driver assembly is inserted into up the hole passing through the receiving support frame and it is located in a location up in the ceiling with the flexible low-voltage LED driver output power supply cable and mating connector exiting out of the receiving surface hole.

In this simplified first embodiment of the present invention, a flexible low-voltage driver output cable is provided from the junction box and LED driver that connects to a mating flexible low-voltage power supply cable exiting the LED light source module. The junction box will have mounting means for permanent installation of the junction box and LED driver to a fixed and rigid surface like a joist or beam, and the flexible low-voltage power supply cable will preferably be housed in a flexible metal shell that is properly to AC ground for continuity and electrical safety. The length of this flexible low-voltage power supply cable is about 12-18 inches long. The LED driver can be replaced by removing it from the junction box assembly through the ceiling or wall receiving surface hole cutout.

An LED light engine module is used in this first embodiment of the present invention. The LED light engine module consists of a finned heat sink, COB or LED emitter(s), LED holder, optical lens, receiving support frame, reflector, and Selectable Color Temperature (SCT) color tunable electronics and switching means for fixed discrete or mixed colors. A trimless or flangeless round trim is easily twisted onto the front of the LED light engine module to the finned heat sink body. The desired beam angles can be determined by replacing the LED optics or reflectors. A ring gasket may be used to make the luminaire WET LOCATION rated for use in a bathroom for example and the trim is available in both round and square shapes.

A plurality of special spring retaining assemblies are attached to the periphery of the finned heat sink to hold the LED light engine module and trim assembly secured to the ceiling or to a wall. A direct push-in motion with fingers on the exposed trim to the center of the receiving support frame hole will easily disengage the LED light engine module and trim assembly from the receiving frame. The end user sets the SCT hardware switch to the desired output color and inserts the LED light engine module back into the ceiling receiving surface and secures it to the receiving frame by engaging the plurality of spring retaining assemblies.

In a second embodiment of the present invention, an improved LED spotlight fixture is disclosed for use in new construction and retrofit remodel installations that can utilize a trimless or flangeless square trim. Installation of the LED spotlight fixture in this embodiment is from above the horizontal or sloped ceiling, but it can also be easily installed into a vertical wall. Installation of the LED spotlight fixture in this second embodiment is from above the ceiling for a new construction application.

The initial step in the installation is to drill a properly sized hole in the ceiling to accommodate the sized spotlight fixture being installed. Once the hole is made, a receiving frame is installed in the hole from below and secured to the ceiling using screws or other attachment means. An optional backing metal support plate may or may not be used above the ceiling. Next, a source of high voltage input AC power is brought to the LED spotlight fixture using either a 3-conductor BX metal armor jacketed cable for New York City use, or a 3-conductor flat Romex cable from above the ceiling and out the receiving surface hole for connection to the LED driver located inside the junction box. Once the LED driver is connected and the respective high voltage input AC power supply cable is secured to the junction box, the entire junction box and LED driver assembly is inserted into up the hole passing through the receiving support frame and it is located in a location up in the ceiling with the flexible low-voltage LED driver output power supply cable and mating connector exiting out of the receiving surface hole.

In this simplified second embodiment of the present invention, a flexible low-voltage driver output cable is provided from the junction box and LED driver that connects to a mating flexible low-voltage power supply cable exiting the LED light source module. The junction box will have mounting means for permanent installation of the junction box and LED driver to a fixed and rigid surface like a joist or beam, and the flexible low-voltage power supply cable will preferably be housed in a flexible metal shell that is properly to AC ground for continuity and electrical safety. The length of this flexible low-voltage power supply cable is about 12-18 inches long. The LED driver can be replaced by removing it from the junction box assembly through the ceiling or wall receiving surface hole cutout.

An LED light engine module is used in this second embodiment of the present invention. The LED light engine module consists of a finned heat sink, COB or LED emitter(s), LED holder, optical lens, receiving support frame, reflector, and Selectable Color Temperature (SCT) color tunable electronics and switching means for fixed discrete or mixed colors. A trimless or flangeless round trim is easily twisted onto the front of the LED light engine module to the finned heat sink body. The desired beam angles can be determined by replacing the LED optics or reflectors. A ring gasket may be used to make the luminaire WET LOCATION rated for use in a bathroom for example and the trim is available in both round and square shapes.

A plurality of special spring retaining assemblies are attached to the periphery of the finned heat sink to hold the LED light engine module and trim assembly secured to the ceiling or to a wall. A direct push-in motion with fingers on the exposed trim to the center of the receiving support frame hole will easily disengage the LED light engine module and trim assembly from the receiving frame. The end user sets the SCT mechanical switch to the desired output color and inserts the LED light engine module back into the ceiling receiving surface and secures it to the receiving support frame by engaging the plurality of spring retaining assemblies.

In a third embodiment of the present invention, an improved LED spotlight fixture is disclosed for use in new construction and retrofit remodel installations that can utilize a trimmed or flanged round trim. Installation of the LED spotlight fixture in this embodiment is from above the horizontal or sloped ceiling, but it can also be easily installed into a vertical wall. Installation of the LED spotlight fixture in this third embodiment is from above the ceiling for a new construction application.

The initial step in the installation is to drill a properly sized hole in the ceiling to accommodate the sized spotlight fixture being installed. Once the hole is made, the flanged round trim serving as the receiving support frame is installed in the hole from below and secured to the ceiling using a pair of snap action lever spring clips or other attachment means. An optional backing metal support plate may or may not be used above the ceiling. Next, a source of high voltage input AC power is brought to the LED spotlight fixture using either a 3-conductor BX metal armor jacketed cable for New York City use, or a 3-conductor flat Romex cable from above the ceiling and out the receiving surface hole for connection to the LED driver located inside the junction box. Once the LED driver is connected and the respective high voltage input AC power supply cable is secured to the junction box, the entire junction box and LED driver assembly is inserted into up the hole passing through the receiving support frame and it is located in a location up in the ceiling with the flexible low-voltage LED driver output power supply cable and mating connector exiting out of the receiving surface hole.

In this simplified third embodiment of the present invention, a flexible low-voltage driver output cable is provided from the junction box and LED driver that connects to a mating flexible low-voltage power supply cable exiting the LED light source module. The junction box will have mounting means for permanent installation of the junction box and LED driver to a fixed and rigid surface like a joist or beam, and the flexible low-voltage power supply cable will preferably be housed in a flexible metal shell that is properly to AC ground for continuity and electrical safety. The length of this flexible low-voltage power supply cable is about 12-18 inches long. The LED driver can be replaced by removing it from the junction box assembly through the ceiling or wall receiving surface hole cutout.

An LED light engine module is used in this third embodiment of the present invention. The LED light engine module consists of a finned heat sink, COB or LED emitter(s), LED holder, optical lens, receiving support frame, reflector, and Selectable Color Temperature (SCT) color tunable electronics and switching means for fixed discrete or mixed colors. A trimless or flangeless round trim is easily twisted onto the front of the LED light engine module to the finned heat sink body. The desired beam angles can be determined by replacing the LED optics or reflectors. A ring gasket may be used to make the luminaire WET LOCATION rated for use in a bathroom for example and the trim is available in both round and square shapes.

A plurality of special spring retaining assemblies are attached to the periphery of the finned heat sink to hold the LED light engine module and trim assembly secured to the ceiling or to a wall. A direct push-in motion with fingers on the exposed trim to the center of the receiving support frame hole will easily disengage the LED light engine module and trim assembly from the receiving support frame. The end user sets the SCT mechanical switch to the desired output color and inserts the LED light engine module back into the ceiling receiving surface and secures it to the receiving support frame by engaging the plurality of spring retaining assemblies.

In a last fourth embodiment of the present invention, an improved LED spotlight fixture is disclosed for use in new construction and retrofit remodel installations that can utilize a trimmed or flanged square trim. Installation of the LED spotlight fixture in this embodiment is from above the horizontal or sloped ceiling, but it can also be easily installed into a vertical wall. Installation of the LED spotlight fixture in this fourth embodiment is from above the ceiling for a new construction application.

The initial step in the installation is to drill a properly sized hole in the ceiling to accommodate the sized spotlight fixture being installed. Once the hole is made, the flanged round trim serving as the receiving support frame is installed in the hole from below and secured to the ceiling using a pair of snap action lever spring clips or other attachment means. An optional backing metal support plate may or may not be used above the ceiling. Next, a source of high voltage input AC power is brought to the LED spotlight fixture using either a 3-conductor BX metal armor jacketed cable for New York City use, or a 3-conductor flat Romex cable from above the ceiling and out the receiving surface hole for connection to the LED driver located inside the junction box. Once the LED driver is connected and the respective high voltage input AC power supply cable is secured to the junction box, the entire junction box and LED driver assembly is inserted into up the hole passing through the receiving support frame and it is located in a location up in the ceiling with the flexible low-voltage LED driver output power supply cable and mating connector exiting out of the receiving surface hole.

In this simplified fourth embodiment of the present invention, a flexible low-voltage driver output cable is provided from the junction box and LED driver that connects to a mating flexible low-voltage power supply cable exiting the LED light source module. The junction box will have mounting means for permanent installation of the junction box and LED driver to a fixed and rigid surface like a joist or beam, and the flexible low-voltage power supply cable will preferably be housed in a flexible metal shell that is properly to AC ground for continuity and electrical safety. The length of this flexible low-voltage power supply cable is about 12-18 inches long. The LED driver can be replaced by removing it from the junction box assembly through the ceiling or wall receiving surface hole cutout.

An LED light engine module is used in this fourth embodiment of the present invention. The LED light engine module consists of a finned heat sink, COB or LED emitter(s), LED holder, optical lens, receiving support frame, reflector, and Selectable Color Temperature (SCT) color tunable electronics and switching means for fixed discrete or mixed colors. A trimless or flangeless round trim is easily twisted onto the front of the LED light engine module to the finned heat sink body. The desired beam angles can be determined by replacing the LED optics or reflectors. A ring gasket may be used to make the luminaire WET LOCATION rated for use in a bathroom for example and the trim is available in both round and square shapes.

A plurality of special spring retaining assemblies are attached to the periphery of the finned heat sink to hold the LED light engine module and trim assembly secured to the ceiling or to a wall. A direct push-in motion with fingers on the exposed trim to the center of the receiving support frame hole will easily disengage the LED light engine module and trim assembly from the receiving support frame. The end user sets the SCT mechanical switch to the desired output color and inserts the LED light engine module back into the ceiling receiving surface and secures it to the receiving support frame by engaging the plurality of spring retaining assemblies.

The disclosure of the many different embodiments of the new recessed anti-glare LED spotlight fixture fixtures of the present invention with improved features is designed and manufactured by Sonlite & Stellarlite Lighting Co., Ltd. based in Foshan, Guangdong Province, China 528251 in an exclusive partnership with Sunshine Lighting Company's parent company Lighting & Supplies, Inc. based in Brooklyn, NY, 11231 USA. In particular, the unique spring retaining assemblies are designed specifically for these LED spotlight fixtures.

### OBJECT OF THE INVENTION

It is an object of the present invention to provide a recessed anti-glare LED spotlight fixture that will work in both a retrofit remodel and in a new installation application.

It is another object of the present invention to provide a recessed anti-glare LED spotlight fixture with improved features over other LED downlights for repairs and maintenance.

It is another object of the present invention to provide a recessed anti-glare LED spotlight fixture where the LED driver is housed in a remote junction box away from the LED light source to reduce waste.

It is yet another object of the present invention to provide a recessed anti-glare LED spotlight fixture without the added cost of extra metal brackets, extension arms, an air-tight box, and hanging bars.

It is also another object of the present invention to provide a recessed anti-glare LED spotlight fixture with changeable fixed focus LED optics but can be used with optional directional films for various other light projections and focusing.

It is also yet another object of the present invention to provide a color selectable and recessed anti-glare LED spotlight fixture with a switch provided on the LED light source assembly itself.

It is also another object of the present invention to provide a recessed anti-glare LED spotlight fixture with a safer and easier to manage the method of engaging and disengaging the LED light source assembly using a plurality of unique push-in spring retaining assemblies.

It is yet another object of the present invention to provide a recessed anti-glare LED spotlight fixture that will use the same LED light engine module and a first regressed anti-glare flangeless trim with a second flanged receiving spackle mud perforated hole trim frame, or a second solid flanged receiving trim frame for both trimless or flangeless as well as flanged trim installations.

A final object of the invention is to provide a recessed anti-glare LED spotlight fixture that will work with different ceiling or wall thicknesses.

While the novel features of the invention are set forth particularly in the appended claims, the invention, both as to organization and content will be better understood and appreciated along with other objects and features thereof, from the following detailed description taken in conjunction with the drawings. These and other aspects, features, and advantages of the present invention will become more readily apparent from the following drawings and the detailed description of the preferred embodiments.

### TABLE OF NUMERALS

FIG. 1

| | |
|---|---|
| 10 | 3″ LED spotlight fixture |
| 20 | round receiving spackle mud frame |
| 30 | 3″ LED light engine module |
| 40 | cable strain relief |
| 50 | rear cover plate |
| 60A, 60B | rear cover plate mounting screws |
| 70 | SCT PCB and switch |
| 80 | finned heat sink |
| 90A, 90B, 90C, 90D | heat sink recessed cavities |
| 100 | COB LED emitter and holder |
| 110A, 110B | COB LED holder mounting screws |
| 120 | reflector |
| 130A, 130B, 130C, 130D | spring retaining assemblies |
| 140 | spring assemblies hold down ring |
| 150 | trim locking ring |
| 160A, 160B, 160C, 160D | trim locking ring mounting screws |
| 170 | round flangeless baffle trim |

FIG. 2

| | |
|---|---|
| 180 | 3″ LED spotlight fixture |
| 190 | square receiving spackle mud frame |
| 200 | 3″ LED light engine module |
| 210 | cable strain relief |
| 220 | rear cover plate |
| 230A, 230B | rear cover plate mounting screws |
| 240 | SCT PCB and switch |
| 250 | finned heat sink |
| 260A, 260B, 260C, 260D | heat sink recessed cavities |
| 270 | COB LED emitter and holder |
| 280A, 280B | COB LED holder mounting screws |
| 290 | reflector |
| 300A, 300B, 300C, 300D | spring retaining assemblies |
| 310 | spring assemblies hold down ring |
| 320 | trim locking ring |
| 330A, 330B, 330C, 330D | trim locking ring mounting screws |
| 340 | square flangeless baffle trim |

FIG. 3

| | |
|---|---|
| 350 | 3″ LED spotlight fixture |
| 360 | round flanged trim receiving frame |
| 370A, 370B | surface snap-action lever spring clips |
| 380 | round flanged trim gasket |
| 390 | 3″ LED light engine module |
| 400 | cable strain relief |
| 410 | rear cover plate |
| 420A, 420B | rear cover plate mounting screws |
| 430 | SCT PCB and switch |
| 440 | finned heat sink |
| 450A, 450B, 450C, 450D | heat sink recessed cavities |
| 460 | COB LED emitter and holder |
| 470A, 470B | COB LED holder mounting screws |
| 480 | reflector |
| 490A, 490B, 490C, 490D | spring retaining assemblies |
| 500 | spring assemblies hold down ring |
| 510 | trim locking ring |
| 520A, 520B, 520C, 520D | trim locking ring mounting screws |
| 530 | round flangeless baffle trim |

FIG. 4

| | |
|---|---|
| 540 | 3″ LED spotlight fixture |
| 550 | square flanged trim receiving frame |
| 560A, 560B | surface snap-action lever spring clips |
| 570 | square flanged trim gasket |
| 580 | 3″ LED light engine module |
| 590 | cable strain relief |
| 600 | rear cover plate |
| 610A, 610B | rear cover plate mounting screws |
| 620 | SCT PCB and switch |
| 630 | finned heat sink |
| 640A, 640B, 640C, 640D | heat sink recessed cavities |
| 650 | COB LED emitter and holder |
| 660A, 660B | COB LED holder mounting screws |
| 670 | reflector |
| 680A, 680B, 680C, 680D | spring retaining assemblies |
| 690 | spring assemblies hold down ring |
| 700 | trim locking ring |
| 710A, 710B, 710C, 710D | trim locking ring mounting screws |
| 720 | square flangeless baffle trim |

FIG. 5

| | |
|---|---|
| 730 | 4″ LED spotlight fixture |
| 740 | round receiving spackle mud frame |
| 750 | 4″ LED light engine module |
| 760 | cable strain relief |
| 770 | rear cover plate |
| 780A, 780B | rear cover plate mounting screws |
| 790 | SCT PCB and switch |
| 800 | finned heat sink |
| 810A, 810B, 810C, | heat sink recessed cavities |
| 810D, 810E, 810F | |
| 820 | COB LED emitter and holder |
| 830A, 830B | COB LED holder mounting screws |
| 840 | reflector |
| 850A, 850B, 850C, | spring retaining assemblies |
| 850D, 850E, 850F | |
| 860 | spring assemblies hold down ring |
| 870 | trim locking ring |
| 880A, 880B, 880C, 880D | trim locking ring mounting screws |
| 890 | round flangeless baffle trim |

FIG. 6

| | |
|---|---|
| 900 | 4″ LED spotlight fixture |
| 910 | square receiving spackle mud frame |
| 920 | 4″ LED light engine module |
| 930 | cable strain relief |
| 940 | rear cover plate |
| 950A, 950B | rear cover plate mounting screws |
| 960 | SCT PCB and switch |
| 970 | finned heat sink |
| 980A, 980B, 980C, | heat sink recessed cavities |
| 980D, 980E, 980F | |
| 990 | COB LED emitter and holder |
| 1000A, 1000B | COB LED holder mounting screws |
| 1010 | reflector |
| 1020A, 1020B, 1020C, | spring retaining assemblies |
| 1020D, 1020E, 1020F | |
| 1030 | spring assemblies hold down ring |
| 1040 | trim locking ring |
| 1050A, 1050B, 1050C, | trim locking ring mounting screws |
| 1050D | |
| 1060 | square flangeless baffle trim |

FIG. 7

| | |
|---|---|
| 1070 | 4″ LED spotlight fixture |
| 1080 | round flanged trim receiving frame |
| 1090A, 1090B | surface snap-action lever spring clips |
| 1100 | round flanged trim gasket |
| 1110 | 4″ LED light engine module |
| 1120 | cable strain relief |
| 1130 | rear cover plate |
| 1140A, 1140B | rear cover plate mounting screws |
| 1150 | SCT PCB and switch |
| 1160 | finned heat sink |
| 1170A, 1170B, 1170C, | heat sink recessed cavities |
| 1170D, 1170E, 1170F | |
| 1180 | COB LED emitter and holder |
| 1190A, 1190B | COB LED holder mounting screws |
| 1200 | reflector |
| 1210A, 1210B, 1210C, | spring retaining assemblies |
| 1210D, 1210E, 1210F | |
| 1220 | spring assemblies hold down ring |
| 1230 | trim locking ring |
| 1240A, 1240B, 1240C, | trim locking ring mounting screws |
| 1240D | |
| 1250 | round flangeless baffle trim |

FIG. 8

| | |
|---|---|
| 1260 | 4″ LED spotlight fixture |
| 1270 | square flanged trim receiving frame |
| 1280A, 1280B | surface snap-action lever spring clips |
| 1290 | square flanged trim gasket |
| 1300 | 4″ LED light engine module |
| 1310 | cable strain relief |
| 1320 | rear cover plate |
| 1330A, 1330B | rear cover plate mounting screws |
| 1340 | SCT PCB and switch |
| 1350 | finned heat sink |
| 1360A, 1360B, 1360C, | heat sink recessed cavities |
| 1360D, 1360E, 1360F | |
| 1370 | COB LED emitter and holder |
| 1380A, 1380B | COB LED holder mounting screws |
| 1390 | reflector |
| 1400A, 1400B, 1400C, | spring retaining assemblies |
| 1400D, 1400E, 1400F | |
| 1410 | spring assemblies hold down ring |
| 1420 | trim locking ring |
| 1430A, 1430B, 1430C, | trim locking ring mounting screws |
| 1430D | |
| 1440 | square flangeless baffle trim |

FIG. 9

| | |
|---|---|
| 1450 | remote junction box |
| 1460 | cable strain relief |
| 1470 | knockout holes |
| 1480A, 1480B | junction box mounting means |
| 1490 | junction box access cover |

FIG. 10

| | |
|---|---|
| 1500 | 2 × 2 receiving spackle mud frame |

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 is an isometric exploded view of a first embodiment of the present invention showing a recessed anti-glare 3″ diameter LED trimless or flangeless round trim spotlight with improved features for new construction and retrofit remodel installations.

FIG. 2 is an isometric exploded view of a second embodiment of the present invention showing a recessed anti-glare 3″ diameter LED trimless or flangeless square trim spotlight with improved features for new construction and retrofit remodel installations.

FIG. 3 is an isometric exploded view of a third embodiment of the present invention showing a recessed anti-glare 3″ diameter LED trimmed or flanged round trim spotlight with improved features for new construction and retrofit remodel installations.

FIG. 4 is an isometric exploded view of a fourth embodiment of the present invention showing a recessed anti-glare 3″ diameter LED trimmed or flanged square trim spotlight with improved features for new construction and retrofit remodel installations.

FIG. 5 is an isometric exploded view of a first alternate embodiment of the present invention showing a recessed anti-glare 4″ diameter LED trimless or flangeless round trim spotlight with improved features for new construction and retrofit remodel installations.

FIG. 6 is an isometric exploded view of a second alternate embodiment of the present invention showing a recessed anti-glare 4″ diameter LED trimless or flangeless square trim spotlight with improved features for new construction and retrofit remodel installations.

FIG. 7 is an isometric exploded view of a third alternate embodiment of the present invention showing a recessed anti-glare 4″ diameter LED trimmed or flanged round trim spotlight with improved features for new construction and retrofit remodel installations.

FIG. 8 is an isometric exploded view of a fourth alternate embodiment of the present invention showing a recessed anti-glare 4″ diameter LED trimmed or flanged square trim spotlight with improved features for new construction and retrofit remodel installations.

FIG. 9 is an isometric view of the remote junction box and integral LED driver for use with the many embodiments of the present invention in different sized LED spotlight fixtures with improved features, a few of which are described in FIGS. 1 to 8.

FIG. 10 is a photograph of a 2×2 multi-cell receiving spackle mud frame as described in FIG. 1 and FIG. 2 for a single round or square 3″ LED light engine module, and in FIG. 5 and FIG. 6 for a single round or square 4″ LED light engine module now showing a special 2×2 matrix for the installation of a total of four round or square LED light engine modules of any diameter size up to and including 10″.

### DETAILED DESCRIPTION

In the following detailed description, reference will be made to the accompanying drawing(s), in which identical functional elements are designated with like numerals. The accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized, and that structural changes and/or substitutions of various elements may be made without departing from the scope and spirit of this disclosure. The following detailed description is, therefore, not to be construed in a limited sense. It is noted that description herein is not intended as an extensive overview, and as such, concepts may be simplified in the interests of clarity and brevity. All documents mentioned in this application are hereby incorporated by reference in their entirety. Any process described in this application may be performed in any order and may omit any of the steps in the process. Processes may also be combined with other processes or steps of other processes.

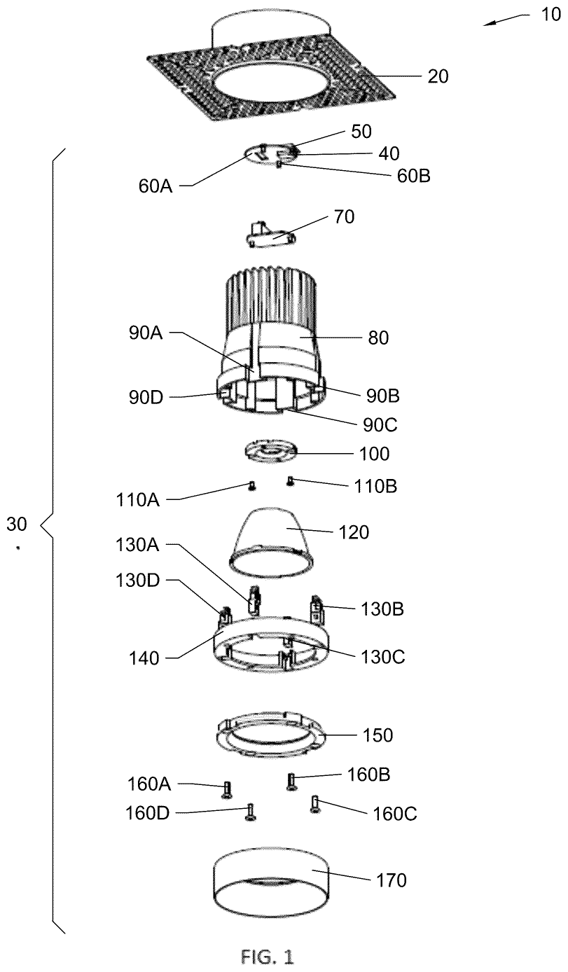

FIG. 1 is an isometric exploded view of a first embodiment of the present invention showing a recessed anti-glare 3″ diameter LED trimless or flangeless round trim spotlight fixture 10 with improved features for new construction and retrofit remodel installations. However, this embodiment may utilize an LED spotlight fixture of any suitable diameter size. In this first embodiment of the present invention, an improved recessed anti-glare 3″ diameter LED trimless or flangeless round trim spotlight fixture 10 is disclosed for use in new construction installations. Installation of the 3″ LED spotlight fixture 10 in this embodiment is from above the horizontal or sloped ceiling, but it can also be easily installed into a vertical wall. For the purposes of this disclosure, the ceiling may be a receiving surface, where the receiving surface may have an upper face and a lower face. For example, the upper face may be “above the ceiling” and the lower face may be “below the ceiling.” Further, the receiving surface may include a hole, or an aperture configured to accept the 3″ LED spotlight fixture 10 and its components thereof.

The initial step in the installation is to drill a properly sized hole or aperture in the receiving ceiling surface using an adequately sized hole saw that will accommodate the sized 3″ LED spotlight fixture 10 being installed. Once the hole is made, a round receiving spackle mud frame 20 is installed up into the hole from below and secured to the ceiling surface using screws (not shown) or other attachment means. An optional backing metal support plate (not shown) may or may not be used above the ceiling for additional support.

A 3″ LED light engine module 30 is used in this first embodiment of the present invention. The 3″ LED light engine module 30 consists of an LED light engine power cable and male connector (not shown); cable strain relief 40; rear cover plate 50; rear cover plate mounting screws 60A and 60B; Selectable Color Temperature (SCT) color tunable electronics printed circuit board (PCB) and switch 70; finned heat sink 80; heat sink recessed cavities 90A, 90B, 90C, and 90D; COB LED emitter and holder 100; COB LED holder mounting screws 110A and 110B; LED optics (not shown); reflector 120; spring retaining assemblies 130A, 130B, 130C, and 130D; spring assemblies hold down ring 140; trim locking ring 150, trim locking ring mounting screws 160A, 160B, 160C, and 160D, and a round flangeless baffle trim 170. The round flangeless baffle trim 170 is easily twisted onto the front of the finned heat sink 80 with the trim locking ring 150 installed for a secured hold. The desired beam angles can be determined by replacing the LED optics (not shown) or reflector 120. An optional protective barrier front lens (not shown) may be used in the 3″ LED light engine module 30 to complete the entire assembly as well as an optional safety cable (not shown) to hold the 3″ LED light engine module 30 to the secured round receiving spackle mud frame 20 during installation.

A plurality of special spring retaining assemblies 130A, 130B, 130C, and 130D are inserted into heat sink recessed cavities 90A, 90B, 90C, and 90D on one end around the periphery of finned heat sink 80 and held in place by spring assemblies hold down ring 140. The plurality of special spring retaining assemblies 130A, 130B, 130C, and 130D engage and hold the complete 3″ LED light engine module 30 and front round flangeless baffle trim 170 securely to the round receiving spackle mud frame 20 mounted to a ceiling or to a wall. A direct push-in motion with fingers on the exposed round flangeless baffle trim 170 at the center of the round receiving spackle mud frame 20 hole will easily disengage the 3″ LED light engine module 30 and front round flangeless baffle trim 170 from the round receiving spackle mud frame 20. The end user sets the SCT PCB and switch 70 to the desired output color and inserts the 3″ LED light engine module 30 back into the ceiling receiving surface (not shown) and secures it to the round receiving spackle mud frame 20 by engaging the plurality of spring retaining assemblies 130A, 130B, 130C, and 130D.

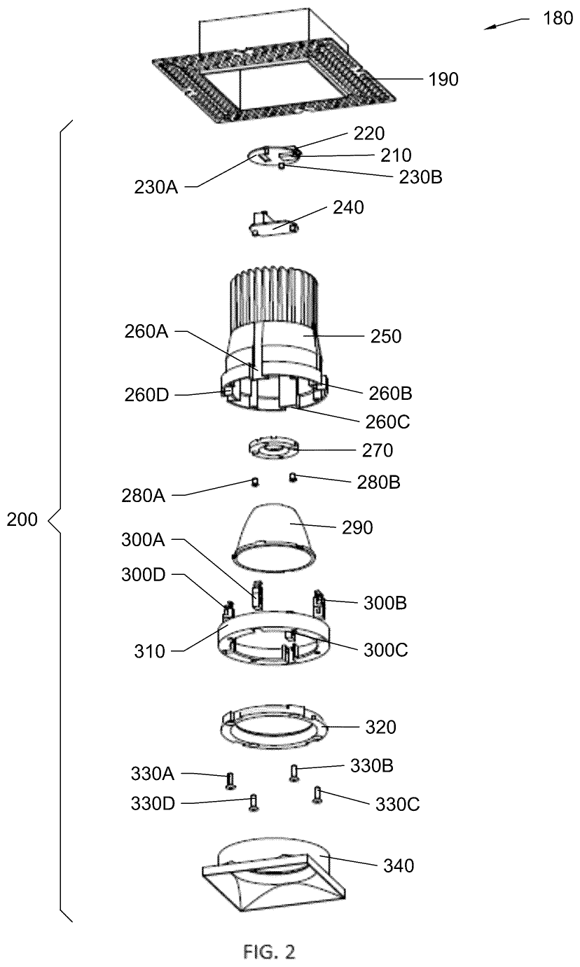

FIG. 2 is an isometric exploded view of a second embodiment of the present invention showing a recessed anti-glare 3″ diameter LED trimless or flangeless square trim spotlight fixture 180 with improved features for new construction and retrofit remodel installations. However, this embodiment may utilize an LED spotlight fixture of any suitable diameter size. In this second embodiment of the present invention, an improved recessed anti-glare 3″ diameter LED trimless or flangeless square trim spotlight fixture 180 is disclosed for use in new construction installations. Installation of the 3″ LED spotlight fixture 180 in this embodiment is from above the horizontal or sloped ceiling, but it can also be easily installed into a vertical wall. For the purposes of this disclosure, the ceiling may be a receiving surface, where the receiving surface may have an upper face and a lower face. For example, the upper face may be “above the ceiling” and the lower face may be “below the ceiling.” Further, the receiving surface may include a hole, or an aperture configured to accept the 3″ LED spotlight fixture 180 and its components thereof.

The initial step in the installation is to drill a properly sized hole or aperture in the receiving ceiling surface using an adequately sized hole saw that will accommodate the sized LED spotlight fixture 180 being installed. Once the hole is made, a square receiving spackle mud frame 190 is installed up into the hole from below and secured to the ceiling surface using screws (not shown) or other attachment means. An optional backing metal support plate (not shown) may or may not be used above the ceiling for additional support.

A 3″ LED light engine module 200 is used in this first embodiment of the present invention. The 3″ LED light engine module 200 consists of an LED light engine power cable and male connector (not shown); cable strain relief 210; rear cover plate 220; rear cover plate mounting screws 230A and 230B; Selectable Color Temperature (SCT) color tunable electronics printed circuit board (PCB) and switch 240; finned heat sink 250; heat sink recessed cavities 260A, 260B, 260C, and 260D; COB LED emitter and holder 270; COB LED holder mounting screws 280A and 280B; LED optics (not shown); reflector 290; spring retaining assemblies 300A, 300B, 300C, and 300D; spring assemblies hold down ring 310; trim locking ring 320, trim locking ring mounting screws 330A, 330B, 330C, and 330D, and a square flangeless baffle trim 340. The square flangeless baffle trim 340 is easily twisted onto the front of the finned heat sink 250 with the trim locking ring 320 installed for a secured hold. The desired beam angles can be determined by replacing the LED optics (not shown) or reflector 290. An optional protective barrier front lens (not shown) may be used in 3″ LED light engine module 200 to complete the entire assembly as well as an optional safety cable (not shown) to hold the 3″ LED light engine module 200 to the secured square receiving spackle mud frame 190 during installation.

A plurality of special spring retaining assemblies 300A, 300B, 300C, and 300D are inserted into heat sink recessed cavities 260A, 260B, 260C, and 260D on one end around the periphery of finned heat sink 250 and held in place by spring assemblies hold down ring 310. The plurality of special spring retaining assemblies 300A, 300B, 300C, and 300D engage and hold the complete 3″ LED light engine module 200 and front square flangeless baffle trim 340 securely to the square receiving spackle mud frame 190 mounted to a ceiling or to a wall. A direct push-in motion with fingers on the exposed square flangeless baffle trim 340 at the center of the square receiving spackle mud frame 190 hole will easily disengage the 3″ LED light engine module 200 and front square flangeless baffle trim 340 from the square receiving spackle mud frame 190. The end user sets the SCT PCB and switch 240 to the desired output color and inserts the 3″ LED light engine module 200 back into the ceiling receiving surface (not shown) and secures it to the square receiving spackle mud frame 190 by engaging the plurality of spring retaining assemblies 300A, 300B, 300C, and 300D.

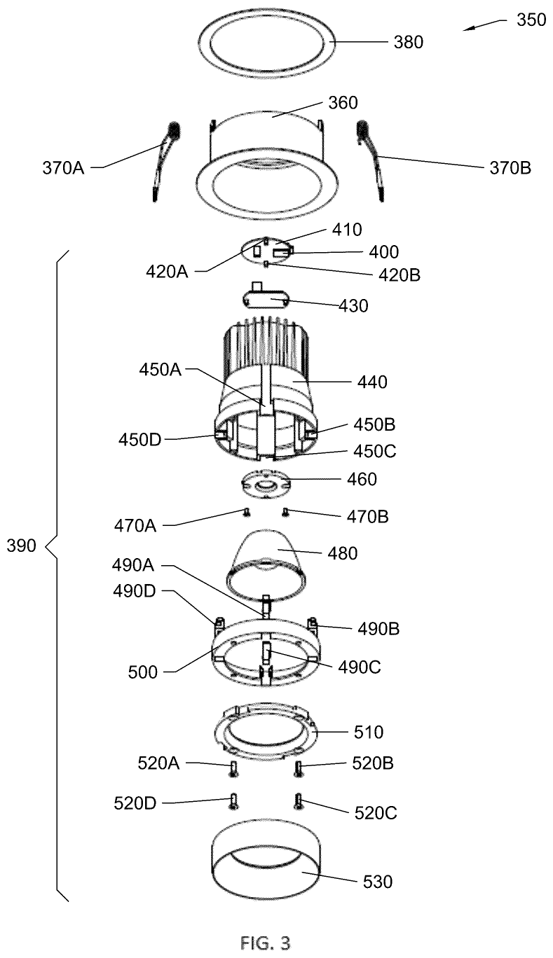

FIG. 3 is an isometric exploded view of a third embodiment of the present invention showing a recessed anti-glare 3″ diameter LED trimmed or flanged round trim spotlight fixture 350 with improved features for new construction and retrofit remodel installations. However, this embodiment may utilize an LED spotlight fixture of any suitable diameter size. In this third embodiment of the present invention, an improved recessed anti-glare 3″ diameter LED trimmed or flanged round trim spotlight fixture 350 is disclosed for use in new construction installations. Installation of the 3″ LED spotlight fixture 350 in this embodiment is from above the horizontal or sloped ceiling, but it can also be easily installed into a vertical wall. For the purposes of this disclosure, the ceiling may be a receiving surface, where the receiving surface may have an upper face and a lower face. For example, the upper face may be “above the ceiling” and the lower face may be “below the ceiling.” Further, the receiving surface may include a hole, or an aperture configured to accept the 3″ LED spotlight fixture 350 and its components thereof.

The initial step in the installation is to drill a properly sized hole or aperture in the receiving ceiling surface using an adequately sized hole saw that will accommodate the sized 3″ LED spotlight fixture 350 being installed. Once the hole is made, a round flanged trim receiving frame 360 is installed up into the hole from below and secured to the ceiling using a pair of surface snap-action lever spring clips 370A and 370B, or other attachment means. A round flanged trim ring gasket 380 may be used on the round flanged trim receiving frame 360 to make the 3″ LED spotlight fixture 350 WET LOCATION rated for use in a bathroom for example. Lastly, an optional backing metal support plate (not shown) may or may not be used above the ceiling for additional support.

A 3″ LED light engine module 390 is used in this third embodiment of the present invention. The 3″ LED light engine module 390 consists of an LED light engine power cable and male connector (not shown); cable strain relief 400; rear cover plate 410; rear cover plate mounting screws 420A and 420B; Selectable Color Temperature (SCT) color tunable electronics printed circuit board (PCB) and switch 430; finned heat sink 440; heat sink recessed cavities 450A, 450B, 450C, and 450D; COB LED emitter and holder 460; COB LED holder mounting screws 470A and 470B; LED optics (not shown); reflector 480; spring retaining assemblies 490A, 490B, 490C, and 490D; spring assemblies hold down ring 500; trim locking ring 510, trim locking ring mounting screws 520A, 520B, 520C, and 520D, and a round flangeless baffle trim 530. The round flangeless baffle trim 530 is easily twisted onto the front of the finned heat sink 440 with the trim locking ring 510 installed for a secure hold. The desired beam angles can be determined by replacing the LED optics (not shown) or reflector 480. An optional protective barrier front lens (not shown) may be used in 3″ LED light engine module 390 to complete the entire assembly as well as an optional safety cable (not shown) to hold the 3″ LED light engine module 390 to the secured round flanged trim receiving frame 360 during installation.

A plurality of special spring retaining assemblies 490A, 490B, 490C, and 490D are inserted into heat sink recessed cavities 450A, 450B, 450C, and 450D on one end around the periphery of finned heat sink 440 and held in place by spring assemblies hold down ring 500. The plurality of special spring retaining assemblies 490A, 490B, 490C, and 490D engage and hold the complete 3″ LED light engine module 390 and front round flangeless baffle trim 530 securely to the round flanged trim receiving frame 360 mounted to a ceiling or to a wall (not shown). A direct push-in motion with fingers on the exposed round flangeless baffle trim 530 at the center of the round flanged trim receiving frame 360 hole will easily disengage the 3″ LED light engine module 390 and front round flangeless baffle trim 530 from the round flanged trim receiving frame 360. The end user sets the SCT PCB and switch 430 to the desired output color and inserts the 3″ LED light engine module 390 back into the ceiling receiving surface (not shown) and secures it to the round flanged trim receiving frame 360 by engaging the plurality of spring retaining assemblies 490A, 490B, 490C, and 490D.

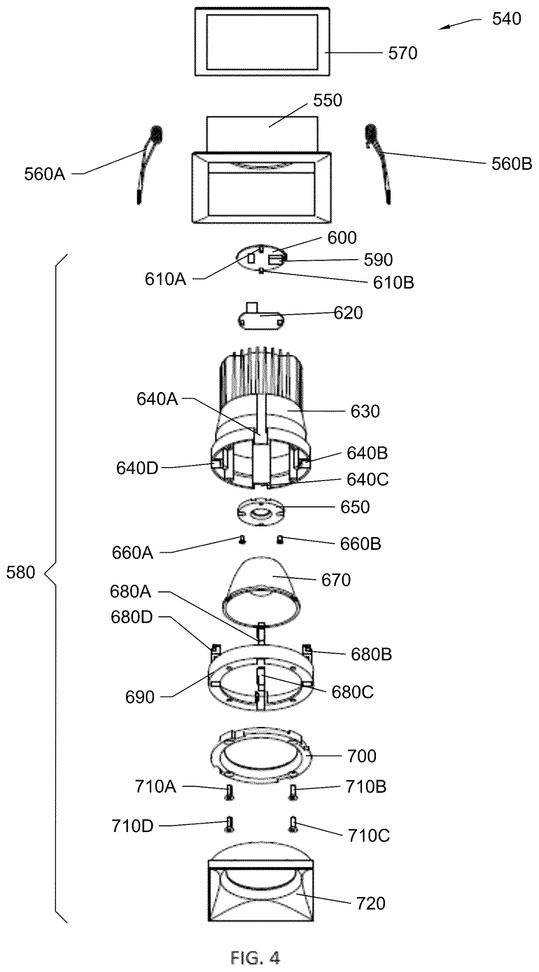

FIG. 4 is an isometric exploded view of a fourth embodiment of the present invention showing a recessed anti-glare 3″ diameter LED trimmed or flanged square trim spotlight fixture 540 with improved features for new construction and retrofit remodel installations. However, this embodiment may utilize an LED spotlight fixture of any suitable diameter size. In this fourth embodiment of the present invention, an improved recessed anti-glare 3″ diameter LED trimmed or flanged square trim spotlight fixture 540 is disclosed for use in new construction installations. Installation of the 3″ LED spotlight fixture 540 in this embodiment is from above the horizontal or sloped ceiling, but it can also be easily installed into a vertical wall. For the purposes of this disclosure, the ceiling may be a receiving surface, where the receiving surface may have an upper face and a lower face. For example, the upper face may be “above the ceiling” and the lower face may be “below the ceiling.” Further, the receiving surface may include a hole, or an aperture configured to accept the 3″ LED spotlight fixture 540 and its components thereof.

The initial step in the installation is to drill a properly sized hole or aperture in the receiving ceiling surface using an adequately sized hole saw that will accommodate the sized 3″ LED spotlight fixture 540 being installed. Once the hole is made, a square flanged trim receiving frame 550 is installed up into the hole from below and secured to the ceiling using a pair of surface snap-action lever spring clips 560A and 560B, or other attachment means. A square flanged trim ring gasket 570 may be used on the square flanged trim receiving frame 550 to make the 3″ LED spotlight fixture 540 WET LOCATION rated for use in a bathroom for example. Lastly, an optional backing metal support plate (not shown) may or may not be used above the ceiling for additional support.

A 3″ LED light engine module 580 is used in this fourth embodiment of the present invention. The 3″ LED light engine module 580 consists of an LED light engine power cable and male connector (not shown); cable strain relief 590; rear cover plate 600; rear cover plate mounting screws 610A and 610B; Selectable Color Temperature (SCT) color tunable electronics printed circuit board (PCB) and switch 620; finned heat sink 630; heat sink recessed cavities 640A, 640B, 640C, and 640D; COB LED emitter and holder 650; COB LED holder mounting screws 660A and 660B; LED optics (not shown); reflector 670; spring retaining assemblies 680A, 680B, 680C, and 680D; spring assemblies hold down ring 690; trim locking ring 700, trim locking ring mounting screws 710A, 710B, 710C, and 710D, and a square flangeless baffle trim 720. The square flangeless baffle trim 720 is easily twisted onto the front of the finned heat sink 630 with the trim locking ring 700 installed for a secure hold. The desired beam angles can be determined by replacing the LED optics (not shown) or reflector 670. An optional protective barrier front lens (not shown) may be used in 3″ LED light engine module 580 to complete the entire assembly as well as an optional safety cable (not shown) to hold the 3″ LED light engine module 580 to the secured square flanged trim receiving frame 550 during installation.

A plurality of special spring retaining assemblies 680A, 680B, 680C, and 680D are inserted into heat sink recessed cavities 640A, 640B, 640C, and 640D on one end around the periphery of finned heat sink 630 and held in place by spring assemblies hold down ring 690. The plurality of special spring retaining assemblies 680A, 680B, 680C, and 680D engage and hold the complete 3″ LED light engine module 580 and front square flangeless baffle trim 720 securely to the square flanged trim receiving frame 550 mounted to a ceiling or to a wall (not shown). A direct push-in motion with fingers on the exposed square flangeless baffle trim 720 at the center of the square flanged trim receiving frame 550 hole will easily disengage the 3″ LED light engine module 580 and front square flangeless baffle trim 720 from the square flanged trim receiving frame 550. The end user sets the SCT PCB and switch 620 to the desired output color and inserts the 3″ LED light engine module 580 back into the ceiling receiving surface (not shown) and secures it to the square flanged trim receiving frame 550 by engaging the plurality of spring retaining assemblies 680A, 680B, 680C, and 680D.

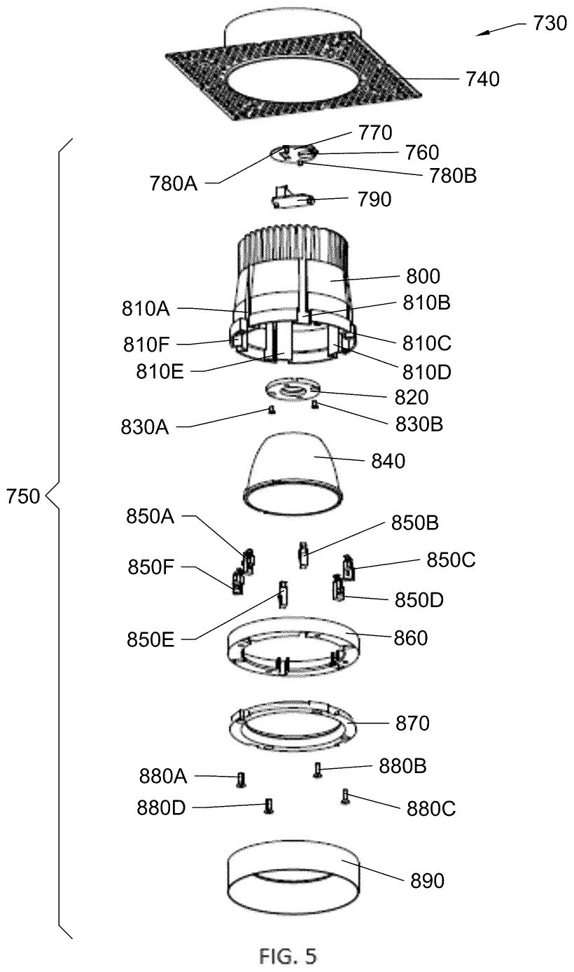

FIG. 5 is an isometric exploded view of a first alternate embodiment of the present invention showing a recessed anti-glare 4″ diameter LED trimless or flangeless round trim spotlight fixture 730 with improved features for new construction and retrofit remodel installations. However, this alternate embodiment may utilize an LED spotlight fixture of any suitable diameter size. In this first alternate embodiment of the present invention, an improved recessed anti-glare 4″ diameter LED trimless or flangeless round trim spotlight fixture 730 is disclosed for use in new construction installations. Installation of the 4″ LED spotlight fixture 730 in this alternate embodiment is from above the horizontal or sloped ceiling, but it can also be easily installed into a vertical wall. For the purposes of this disclosure, the ceiling may be a receiving surface, where the receiving surface may have an upper face and a lower face. For example, the upper face may be “above the ceiling” and the lower face may be “below the ceiling.” Further, the receiving surface may include a hole, or an aperture configured to accept the 4″ LED spotlight fixture 730 and its components thereof.

The initial step in the installation is to drill a properly sized hole or aperture in the receiving ceiling surface using an adequately sized hole saw that will accommodate the sized 4″ LED spotlight fixture 730 being installed. Once the hole is made, a round receiving spackle mud frame 740 is installed up into the hole from below and secured to the ceiling surface using screws (not shown) or other attachment means. An optional backing metal support plate (not shown) may or may not be used above the ceiling for additional support.

A 4″ LED light engine module 750 is used in this first alternate embodiment of the present invention. The 4″ LED light engine module 750 consists of an LED light engine power cable and male connector (not shown); cable strain relief 760; rear cover plate 770; rear cover plate mounting screws 780A and 780B; Selectable Color Temperature (SCT) color tunable electronics printed circuit board (PCB) and switch 790; finned heat sink 800; heat sink recessed cavities 810A, 810B, 810C, 810D, 810E, and 810F; COB LED emitter and holder 820; COB LED holder mounting screws 830A and 830B; LED optics (not shown); reflector 840; spring retaining assemblies 850A, 850B, 850C, 850D, 850E, and 850F; spring assemblies hold down ring 860; trim locking ring 870, trim locking ring mounting screws 880A, 880B, 880C, and 880D, and a round flangeless baffle trim 890. The round flangeless baffle trim 890 is easily twisted onto the front of the finned heat sink 800 with the trim locking ring 870 installed for a secured hold. The desired beam angles can be determined by replacing the LED optics (not shown) or reflector 840. An optional protective barrier front lens (not shown) may be used in the 4″ LED light engine module 750 to complete the entire assembly as well as an optional safety cable (not shown) to hold the 4″ LED light engine module 750 to the secured round receiving spackle mud frame 740 during installation.

A plurality of special spring retaining assemblies 850A, 850B, 850C, 850D, 850E, and 850F are inserted into heat sink recessed cavities 810A, 810B, 810C, 810D, 810E, and 810F on one end around the periphery of finned heat sink 800 and held in place by spring assemblies hold down ring 860. The plurality of special spring retaining assemblies 850A, 850B, 850C, 850D, 850E, and 850F engage and hold the complete 4″ LED light engine module 750 and front round flangeless baffle trim 890 securely to the round receiving spackle mud frame 740 mounted to a ceiling or to a wall. A direct push-in motion with fingers on the exposed round flangeless baffle trim 890 at the center of the round receiving spackle mud frame 740 hole will easily disengage the 4″ LED light engine module 750 and front round flangeless baffle trim 890 from the round receiving spackle mud frame 740. The end user sets the SCT PCB and switch 790 to the desired output color and inserts the 4″ LED light engine module 750 back into the ceiling receiving surface (not shown) and secures it to the round receiving spackle mud frame 740 by engaging the plurality of spring retaining assemblies 850A, 850B, 850C, 850D, 850E, and 850F.

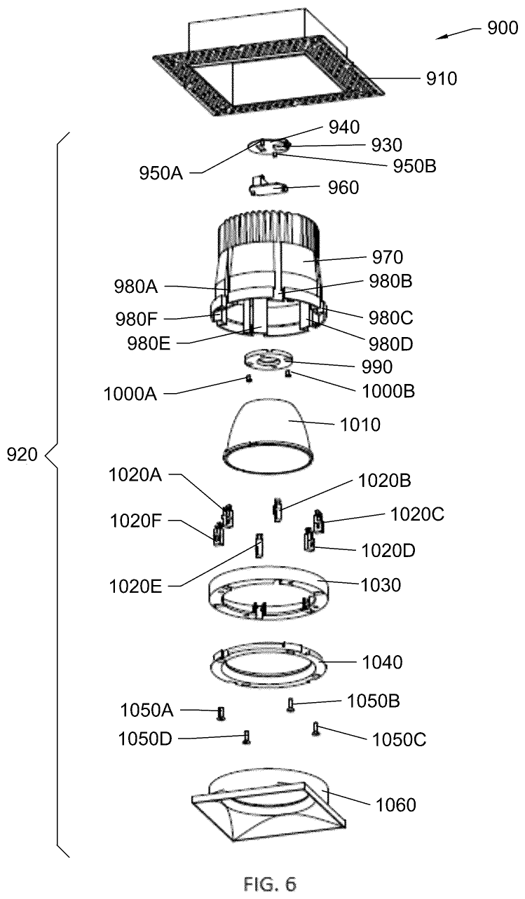

FIG. 6 is an isometric exploded view of a second alternate embodiment of the present invention showing a recessed anti-glare 4″ diameter LED trimless or flangeless square trim spotlight fixture 900 with improved features for new construction and retrofit remodel installations. However, this alternate embodiment may utilize an LED spotlight fixture of any suitable diameter size. In this second alternate embodiment of the present invention, an improved recessed anti-glare 4″ diameter LED trimless or flangeless square trim spotlight fixture 900 is disclosed for use in new construction installations. Installation of the 4″ LED spotlight fixture 900 in this alternate embodiment is from above the horizontal or sloped ceiling, but it can also be easily installed into a vertical wall. For the purposes of this disclosure, the ceiling may be a receiving surface, where the receiving surface may have an upper face and a lower face. For example, the upper face may be “above the ceiling” and the lower face may be “below the ceiling.” Further, the receiving surface may include a hole, or an aperture configured to accept the 4″ LED spotlight fixture 900 and its components thereof.

The initial step in the installation is to drill a properly sized hole or aperture in the receiving ceiling surface using an adequately sized hole saw that will accommodate the sized LED spotlight fixture 900 being installed. Once the hole is made, a square receiving spackle mud frame 910 is installed up into the hole from below and secured to the ceiling surface using screws (not shown) or other attachment means. An optional backing metal support plate (not shown) may or may not be used above the ceiling for additional support.

A 4″ LED light engine module 920 is used in this first alternate embodiment of the present invention. The 4″ LED light engine module 920 consists of an LED light engine power cable and male connector (not shown); cable strain relief 930; rear cover plate 940; rear cover plate mounting screws 950A and 950B; Selectable Color Temperature (SCT) color tunable electronics printed circuit board (PCB) and switch 960; finned heat sink 970; heat sink recessed cavities 980A, 980B, 980C, 980D, 980E, and 980F; COB LED emitter and holder 990; COB LED holder mounting screws 1000A and 1000B; LED optics (not shown); reflector 1010; spring retaining assemblies 1020A, 1020B, 1020C, 1020D, 1020E, and 1020F; spring assemblies hold down ring 1030; trim locking ring 1040, trim locking ring mounting screws 1050A, 1050B, 1050C, and 1050D, and a square flangeless baffle trim 1060. The square flangeless baffle trim 1060 is easily twisted onto the front of the finned heat sink 970 with the trim locking ring 1040 installed for a secured hold. The desired beam angles can be determined by replacing the LED optics (not shown) or reflector 1010. An optional protective barrier front lens (not shown) may be used in 4″ LED light engine module 920 to complete the entire assembly as well as an optional safety cable (not shown) to hold the 4″ LED light engine module 920 to the secured square receiving spackle mud frame 910 during installation.

A plurality of special spring retaining assemblies 1020A, 1020B, 1020C, 1020D, 1020E, and 1020F are inserted into heat sink recessed cavities 980A, 980B, 980C, 980D, 980E, and 980F on one end around the periphery of finned heat sink 970 and held in place by spring assemblies hold down ring 1030. The plurality of special spring retaining assemblies 1020A, 1020B, 1020C, 1020D, 1020E, and 1020F engage and hold the complete 4″ LED light engine module 920 and front square flangeless baffle trim 1060 securely to the square receiving spackle mud frame 910 mounted to a ceiling or to a wall. A direct push-in motion with fingers on the exposed square flangeless baffle trim 1060 at the center of the square receiving spackle mud frame 910 hole will easily disengage the 4″ LED light engine module 920 and front square flangeless baffle trim 1060 from the square receiving spackle mud frame 910. The end user sets the SCT PCB and switch 960 to the desired output color and inserts the 4″ LED light engine module 920 back into the ceiling receiving surface (not shown) and secures it to the square receiving spackle mud frame 910 by engaging the plurality of spring retaining assemblies 1020A, 1020B, 1020C, 1020D, 1020E, and 1020F.

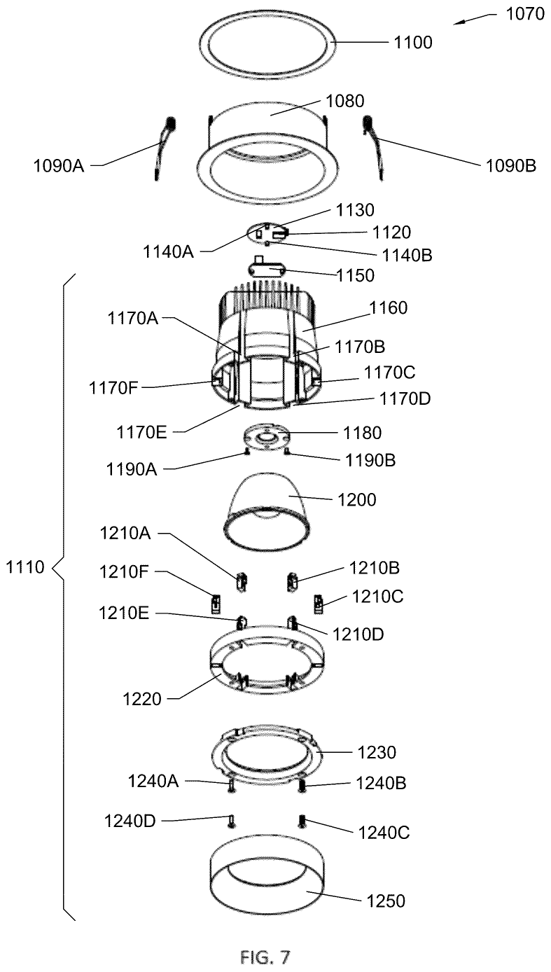

FIG. 7 is an isometric exploded view of a third alternate embodiment of the present invention showing a recessed anti-glare 4″ diameter LED trimmed or flanged round trim spotlight fixture 1070 with improved features for new construction and retrofit remodel installations. However, this alternate embodiment may utilize an LED spotlight fixture of any suitable diameter size. In this third alternate embodiment of the present invention, an improved recessed anti-glare 4″ diameter LED trimmed or flanged round trim spotlight fixture 1070 is disclosed for use in new construction installations. Installation of the 4″ LED spotlight fixture 1070 in this alternate embodiment is from above the horizontal or sloped ceiling, but it can also be easily installed into a vertical wall. For the purposes of this disclosure, the ceiling may be a receiving surface, where the receiving surface may have an upper face and a lower face. For example, the upper face may be “above the ceiling” and the lower face may be “below the ceiling.” Further, the receiving surface may include a hole, or an aperture configured to accept the 4″ LED spotlight fixture 1070 and its components thereof.

The initial step in the installation is to drill a properly sized hole or aperture in the receiving ceiling surface using an adequately sized hole saw that will accommodate the sized 4″ LED spotlight fixture 1070 being installed. Once the hole is made, a round flanged trim receiving frame 1080 is installed up into the hole from below and secured to the ceiling using a pair of surface snap-action lever spring clips 1090A and 1090B, or other attachment means. A round flanged trim ring gasket 1100 may be used on the round flanged trim receiving frame 1080 to make the 4″ LED spotlight fixture 1070 WET LOCATION rated for use in a bathroom for example. Lastly, an optional backing metal support plate (not shown) may or may not be used above the ceiling for additional support.

A 4″ LED light engine module 1110 is used in this third alternate embodiment of the present invention. The 4″ LED light engine module 1110 consists of an LED light engine power cable and male connector (not shown); cable strain relief 1120; rear cover plate 1130; rear cover plate mounting screws 1140A and 1140B; Selectable Color Temperature (SCT) color tunable electronics printed circuit board (PCB) and switch 1150; finned heat sink 1160; heat sink recessed cavities 1170A, 1170B, 1170C, 1170D, 1170E, and 1170F; COB LED emitter and holder 1180; COB LED holder mounting screws 1190A and 1190B; LED optics (not shown); reflector 1200; spring retaining assemblies 1210A, 1210B, 1210C, 1210D, 1210E, and 1210F; spring assemblies hold down ring 1220; trim locking ring 1230, trim locking ring mounting screws 1240A, 1240B, 1240C, and 1230D, and a round flangeless baffle trim 1250. The round flangeless baffle trim 1250 is easily twisted onto the front of the finned heat sink 1160 with the trim locking ring 1230 installed for a secure hold. The desired beam angles can be determined by replacing the LED optics (not shown) or reflector 1200. An optional protective barrier front lens (not shown) may be used in 4″ LED light engine module 1110 to complete the entire assembly an optional safety cable (not shown) to hold the 4″ LED light engine module 1110 to the secured round flanged trim receiving frame 1080 during installation.

A plurality of special spring retaining assemblies 1210A, 1210B, 1210C, 1210D, 1210E, and 1210F are inserted into heat sink recessed cavities 1170A, 1170B, 1170C, 1170D, 1170E, and 1170F on one end around the periphery of finned heat sink 1160 and held in place by spring assemblies hold down ring 860. The plurality of special spring retaining assemblies 1210A, 1210B, 1210C, 1210D, 1210E, and 1210F engage and hold the complete 4″ LED light engine module 1110 and front round flangeless baffle trim 1250 securely to the round flanged trim receiving frame 1080 mounted to a ceiling or to a wall (not shown). A direct push-in motion with fingers on the exposed round flangeless baffle trim 1250 at the center of the round flanged trim receiving frame 1080 hole will easily disengage the 4″ LED light engine module 1110 and front round flangeless baffle trim 1250 from the round flanged trim receiving frame 1080. The end user sets the SCT PCB and switch 1150 to the desired output color and inserts the 4″ LED light engine module 1110 back into the ceiling receiving surface (not shown) and secures it to the round flanged trim receiving frame 1080 by engaging the plurality of spring retaining assemblies 1210A, 1210B, 1210C, 1210D, 1210E, and 1210F.

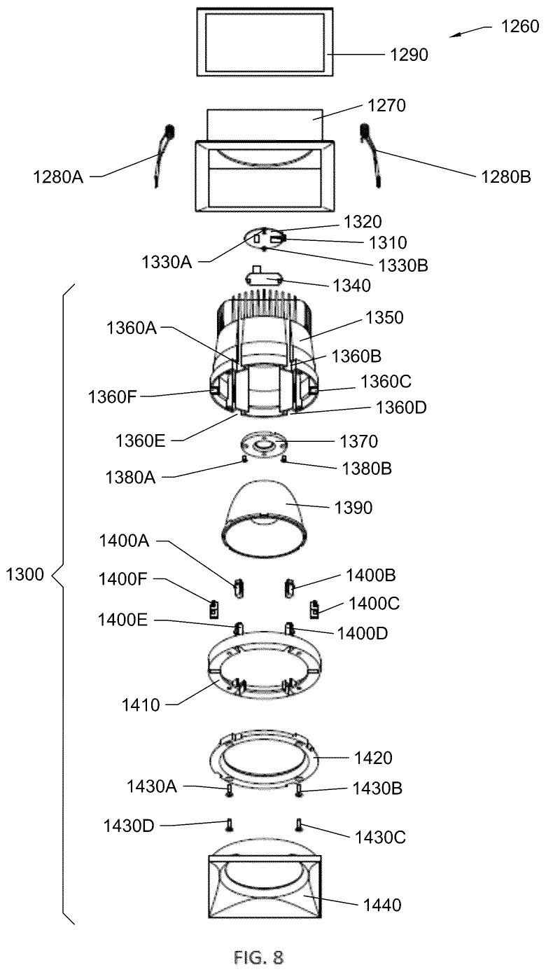

FIG. 8 is an isometric exploded view of a fourth alternate embodiment of the present invention showing a recessed anti-glare 4″ diameter LED trimmed or flanged square trim spotlight fixture 1260 with improved features for new construction and retrofit remodel installations. However, this alternate embodiment may utilize an LED spotlight fixture of any suitable diameter size. In this fourth alternate embodiment of the present invention, an improved recessed anti-glare 4″ diameter LED trimmed or flanged square trim spotlight fixture 1260 is disclosed for use in new construction installations. Installation of the 4″ LED spotlight fixture 1260 in this alternate embodiment is from above the horizontal or sloped ceiling, but it can also be easily installed into a vertical wall. For the purposes of this disclosure, the ceiling may be a receiving surface, where the receiving surface may have an upper face and a lower face. For example, the upper face may be “above the ceiling” and the lower face may be “below the ceiling.” Further, the receiving surface may include a hole, or an aperture configured to accept the 4″ LED spotlight fixture 1260 and its components thereof.

The initial step in the installation is to drill a properly sized hole or aperture in the receiving ceiling surface using an adequately sized hole saw that will accommodate the sized 4″ LED spotlight fixture 1260 being installed. Once the hole is made, a square flanged trim receiving frame 1270 is installed up into the hole from below and secured to the ceiling using a pair of surface snap-action lever spring clips 1280A and 1280B, or other attachment means. A square flanged trim ring gasket 1290 may be used on the square flanged trim receiving frame 1270 to make the 4″ LED spotlight fixture 1260 WET LOCATION rated for use in a bathroom for example. Lastly, an optional backing metal support plate (not shown) may or may not be used above the ceiling for additional support.

A 4″ LED light engine module 1300 is used in this fourth alternate embodiment of the present invention. The 4″ LED light engine module 1300 consists of an LED light engine power cable and male connector (not shown); cable strain relief 1310; rear cover plate 1320; rear cover plate mounting screws 1330A and 1330B; Selectable Color Temperature (SCT) color tunable electronics printed circuit board (PCB) and switch 1340; finned heat sink 1350; heat sink recessed cavities 1360A, 1360B, 1360C, 1360D, 1360E, and 1360F; COB LED emitter and holder 1370; COB LED holder mounting screws 1380A and 1380B; LED optics (not shown); reflector 1390; spring retaining assemblies 1400A, 1400B, 1400C, 1400D, 1400E, and 1400F; spring assemblies hold down ring 1410; trim locking ring 1420, trim locking ring mounting screws 1430A, 1430B, 1430C, and 1430D, and a square flangeless baffle trim 1440. The square flangeless baffle trim 1440 is easily twisted onto the front of the finned heat sink 1350 with the trim locking ring 1420 installed for a secure hold. The desired beam angles can be determined by replacing the LED optics (not shown) or reflector 1390. An optional protective barrier front lens (not shown) may be used in 4″ LED light engine module 1300 to complete the entire assembly as well as an optional safety cable (not shown) to hold the 4″ LED light engine module 1300 to the secured square flanged trim receiving frame 1270 during installation.

A plurality of special spring retaining assemblies 1400A, 1400B, 1400C, 1400D, 1400E, and 1400F are inserted into heat sink recessed cavities 1360A, 1360B, 1360C, 1360D, 1360E, and 1360F on one end around the periphery of finned heat sink 1350 and held in place by spring assemblies hold down ring 1410. The plurality of special spring retaining assemblies 1400A, 1400B, 1400C, 1400D, 1400E, and 1400F engage and hold the complete 4″ LED light engine module 1300 and front square flangeless baffle trim 1440 securely to the square flanged trim receiving frame 1270 mounted to a ceiling or to a wall (not shown). A direct push-in motion with fingers on the exposed square flangeless baffle trim 1440 at the center of the square flanged trim receiving frame 1270 hole will easily disengage the 4″ LED light engine module 1300 and front square flangeless baffle trim 1440 from the square flanged trim receiving frame 1270. The end user sets the SCT PCB and switch 1340 to the desired output color and inserts the 4″ LED light engine module 1300 back into the ceiling receiving surface (not shown) and secures it to the square flanged trim receiving frame 1270 by engaging the plurality of spring retaining assemblies 1400A, 1400B, 1400C, 1400D, 1400E, and 1400F.

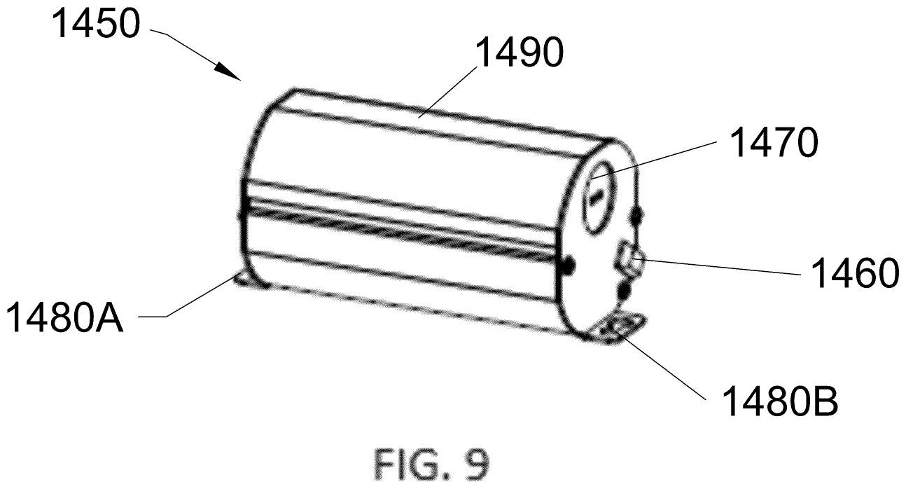

FIG. 9 is an isometric view of the remote junction box 1450 and integral LED driver (not shown) for use with the many embodiments of the present invention in different size LED spotlight fixtures including 3″ LED spotlight fixtures 10, 180, 350, 540 and 4″ LED spotlight fixtures 730, 900, 1070, 1260, a few of which are described in FIGS. 1 to 8.

The remote junction box 1450 may include one or more apertures also known in the art as knockout holes 1470 configured to accept fasteners or to allow for travel of cables. For example, such knockout holes 1470 may allow for cables to carry information or electricity to and/or from the remote junction box 1450. However, in another embodiment, the remote junction box 1450 may be uniformly sealed. Although, if required by a particular embodiment, the remote junction box 1450 may include knockout holes 1470 that are filled by required cables, such as low voltage power supply cable secured by cable strain relief 1460 to 3″ LED light engine modules 30, 200, 390, 580 and 4″ LED light engine modules 750, 920, 1110, 1300.

A source of high voltage input AC power is brought into 3″ LED spotlight fixtures 10, 180, 350, 540 and 4″ LED spotlight fixtures 730, 900, 1070, 1260 through any one of knockout holes 1470 using either a 3-conductor BX metal armor jacketed cable for New York City use, or a 3-conductor flat Romex cable from above the ceiling and out the receiving surface for direct connection to an LED driver (not shown) located inside a remote junction box 1450. Once the LED driver is connected and the respective high voltage input AC power supply cable is secured to the remote junction box 1450 by a suitable BX or Romex strain relief (not shown), the entire remote junction box 1450 and LED driver assembly is inserted back up into the receiving surface hole, passing through the round or square receiving spackle mud frames 20, 190, 740, 910 or round or square receiving flanged trim frames 360, 550, 1080, 1270 in a location up in the ceiling with the flexible low-voltage LED driver output power supply cable (not shown) and mating connector (not shown) exiting out of the receiving surface hole.

In this simplified embodiment of the present invention, a flexible low-voltage driver output cable (not shown) is provided from the remote junction box 1450 and LED driver (not shown) that connects to a mating flexible low-voltage power supply cable (not shown) exiting from each respective 3″ and 4″ LED light source modules 30, 200, 390, 580, 750, 920, 1110, and 1300. The mating flexible low-voltage power supply cable (not shown) is held in place to the remote junction box 1450 by cable strain relief 1460. The remote junction box 1450 will have junction box mounting means 1480A and 1480B for permanent installation of the remote junction box 1450 and internal LED driver (not shown) to a fixed and rigid surface like a joist or beam (not shown). Junction box mounting means 1480A and 1480B include tabs with holes for a screw or other fastener to attach remote junction box 1450 to a rigid structure above the ceiling or behind a wall. The flexible low-voltage power supply cable will preferably be housed in a flexible metal shell that is properly bonded to AC ground for continuity and electrical safety. The length of this flexible low-voltage power supply cable (not shown) may be about 12-18 inches long. The internal LED driver (not shown) can be replaced by removing it from the remote junction box 1450 through the ceiling or wall receiving surface hole cutout.

In an embodiment, the remote junction box 1450 includes a junction box cover 1490 that allows access to the inside of remote junction box 1450. The LED driver (not shown) is replaced by removing it from the entire remote junction box 1450 assembly through a ceiling hole cutout (not shown). For example, the internal LED driver and remote junction box 1450 must be sized such that they may be removed through the hole in the receiving surface sized also to accept the respective LED spotlight fixtures including 3″ LED spotlight fixtures 10, 180, 350, 540 and 4″ LED spotlight fixtures 730, 900, 1070, 1260. Thus, at least one of the dimensions of the remote junction box 1450 may be smaller than the overall diameter of the LED spotlight fixtures including 3″ LED spotlight fixtures 10, 180, 350, 540 and 4″ LED spotlight fixtures 730, 900, 1070, 1260 and/or the mounting hole in the ceiling.

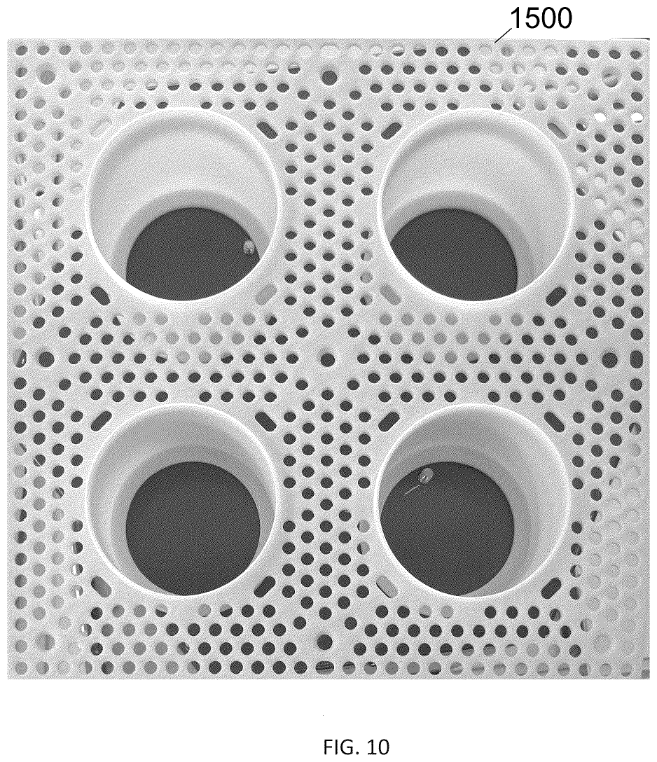

FIG. 10 is a photograph of a 2×2 receiving spackle mud frame as described in FIG. 1 and FIG. 2 for a single-cell round or square 3″ LED light engine module, and in FIG. 5 and FIG. 6 for a single-cell round or square 4″ LED light engine module now showing a special 2×2 multi-cell matrix for the installation of a total of four round or square LED light engine modules of any diameter size up to and including 10″. Besides 2×2, other cell matrix configurations can be made including 1×1, 1×2, 1×3, 1×4, 2×4, or any combination of single cell 1×1 arranged in linear and non-linear configurations (not shown). In addition, the multi-cell matrix configuration for the disclosed 2×2 receiving spackle mud frame can be substituted for a solid trimmed or flanged trim receiving frame for round or square LED light engine modules of any diameter size up to and including 10″ (not shown).

Each individual LED light engine module will be connected to a separate, dedicated remote junction box and LED driver assembly as described in FIG. 9, but an alternate configuration may be to use a single common remote junction box and internal LED driver assembly (not shown) with multiple long lead low-voltage driver output channels each powering one LED light engine module (not shown). This alternate configuration would help reduce the number of high-voltage input service power connections and will allow only low-voltage power supply cords from the LED driver to each LED light module (not shown) for safety and ease of connections.

For the purposes of this disclosure, similar elements, limitations, parts, or components of downlights of the various embodiments recited herein may further share component-specific characteristics across said various embodiments. Thus, the characteristics of components should not be read as limiting to the embodiment of descriptive origin.

SMD may refer to “Surface Mounted Device” LEDs. In such SMD LEDs the LED chip may be permanently fixed to a printed circuit board (“PCB”). In various embodiments, the SMD LED chips may include two or more contacts. As a non-limiting example, each diode may include an individual circuit. Accordingly, an SMD LED comprising multiple diodes (for example, three different colored diodes) may output an assortment of colors by blending and adjusting the output levels of each diode.

COB may refer to “Chip on Board.” A COB LED may include more than one diode. In an embodiment, a COB LED may include a greater number of diodes than a SMD LED. As a non-limiting example, a COB LED may include nine or more diodes. Further, a COB LED may include a single circuit and two contacts, independent of the number of diodes. Accordingly, a COB LED may include a flatter structure than a SMD LED.

For the purposes of this disclosure, a COB or “chip-on-board” LED emitter may consist of multiple LED chips or diodes connected internally to form a typically round light source. A lighting fixture may utilize one COB LED emitter mounted on a substrate, or a circuit board with multiple discrete single chips, or single die LED emitters arranged in an array, to form a concentrated light area for best lumen output. Thus, according to the desired application, downlights as described herein may include COB LED(s) and/or SMD LED(s).

It will be understood that various changes in the details, materials, types, values, and arrangements of the components that have been described and illustrated in order to explain the nature of this invention may be made by those skilled in the art without departing from the principle and scope of the invention as expressed in the following claims. Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What we claim is:

1. A recessed anti-glare LED spotlight fixture including:
a remote junction box disposed to a receiving surface;
a receiving support frame mounted to said receiving surface;
an LED driver disposed in said remote junction box;
a first flexible low-voltage power supply cable exiting said remote junction box in electrical communication with said LED driver and terminating in a first electrical cable locking connector;
an LED light engine module including a light source in electrical communication with said LED driver by way of a second flexible low-voltage power supply cable exiting said LED light engine module and terminating in a second electrical cable locking connector that is in electrical communication to said first electrical cable locking connector of said first low-voltage power supply cable;
said first electrical cable locking connector and said second electrical cable locking connector removably mate together; and
a plurality of spring retaining assemblies for easy inserting and removing said LED light engine module in and out of said receiving support frame in juxtaposition to said receiving surface.

2. The recessed anti-glare LED spotlight fixture of claim 1, further including:
a hardware switch positioned in said LED light engine module to manually set a color temperature of said light source.

3. The recessed anti-glare LED spotlight fixture of claim 1, wherein the LED light engine module further including:
interchangeable round and square baffle trims; and
interchangeable reflector or changeable LED optics.

4. The recessed anti-glare LED spotlight fixture of claim 1, wherein the LED light engine module further including:
a protective barrier front lens.

5. The recessed anti-glare LED spotlight fixture of claim 1, wherein the receiving support frame mounted to said receiving surface is a trimless spackle mud plate.

6. The recessed anti-glare LED spotlight fixture of claim 1, wherein the receiving support frame mounted to said receiving surface is a flanged round trim.

7. The recessed anti-glare LED spotlight fixture of claim 6, wherein the flanged round trim includes at least two spring clips for installation into said receiving surface.

8. The recessed anti-glare LED spotlight fixture of claim 1, wherein the receiving support frame mounted to said receiving surface is a flanged square trim.

9. The recessed anti-glare LED spotlight fixture of claim 8, wherein the flanged square trim includes at least two spring clips for installation into said receiving surface.

10. The recessed anti-glare LED spotlight fixture of claim 1, wherein the plurality of spring retaining assemblies includes at least three spring retaining assemblies.

11. The recessed anti-glare LED spotlight fixture of claim 1, wherein the receiving support frame mounted to said receiving surface can accommodate at least one LED light engine module.

12. The recessed anti-glare LED spotlight fixture of claim 11, wherein the receiving support frame mounted to said receiving surface is a spackle mud plate.

13. The recessed anti-glare LED spotlight fixture of claim 11, wherein the receiving support frame mounted to said receiving surface is a flanged round trim.

14. The recessed anti-glare LED spotlight fixture of claim 11, wherein the receiving support frame mounted to said receiving surface is a flanged square trim.

15. The recessed anti-glare LED spotlight fixture of claim 11, wherein each LED light engine module is in communication with a separate LED driver.

16. The recessed anti-glare LED spotlight fixture of claim 11, wherein each LED light engine module is in communication with a common LED driver.

17. A method for accessing an LED driver for replacement comprising the following steps:
removing an LED light engine from a receiving hole by pushing up on a plurality of spring retaining assemblies disengaging said LED light engine from a receiving support frame;
wherein the receiving hole is bound by a receiving surface;
pulling on an electrical connection between the LED light engine and the LED driver through the receiving hole;
disengaging a junction box cover to access the LED driver from a junction box;
wherein the junction box cover is reversibly attached to the junction box;
disengaging a first electrical connection between the LED driver and LED light engine;
disengaging a second electrical connection between the LED driver and an input power;
and removing the LED driver.

18. The method of claim 17, further comprising the steps of:
engaging the replacement LED driver to the junction box;
engaging the first electrical connection between the replacement LED driver to the LED light engine;
engaging the second electrical connection between the replacement LED driver to input power;
reattaching the junction box cover to the junction box;
manually inserting the junction box and LED driver assembly back into said receiving surface and place some distance from the receiving hole; and
depositing the LED light engine through the receiving hole by pushing up on a plurality of spring retaining assemblies engaging it back onto said receiving support frame.

19. The recessed anti-glare LED spotlight fixture of claim 18, wherein the receiving support frame mounted to said receiving surface is a spackle mud plate.

20. The recessed anti-glare LED spotlight fixture of claim 18, wherein the receiving support frame mounted to said receiving surface is a flanged round trim.

21. The recessed anti-glare LED spotlight fixture of claim 20, wherein the flanged round trim includes at least two spring clips for installation into said receiving surface.

22. The recessed anti-glare LED spotlight fixture of claim 18, wherein the receiving support frame mounted to said receiving surface is a flanged square trim.

23. The recessed anti-glare LED spotlight fixture of claim 22, wherein the flanged square trim includes at least two spring clips for installation into said receiving surface.

24. A recessed anti-glare LED spotlight fixture including:
a remote junction box disposed to a receiving surface;
a receiving support frame mounted to said receiving surface;
an LED driver disposed in said remote junction box;
a first flexible low-voltage power supply cable exiting said remote junction box in electrical communication with said LED driver and terminating in a first electrical cable locking connector;
an LED light engine module including a light source in electrical communication with said LED driver by way of a second flexible low-voltage power supply cable exiting said LED light engine module and terminating in a second electrical cable locking connector that is in electrical communication to said first electrical cable locking connector of said first low-voltage power supply cable;
said first electrical cable locking connector and said second electrical cable locking connector removably mate together;
a plurality of spring retaining assemblies for easy inserting and removing said LED light engine module in and out of said receiving support frame in juxtaposition to said receiving surface;
a hardware switch positioned in said LED light engine module to manually set a color temperature of said light source;
interchangeable round and square baffle trims; and
interchangeable reflector or changeable LED optics.

25. The recessed anti-glare LED spotlight fixture of claim 24, wherein the receiving support frame mounted to said receiving surface is a spackle mud plate.

26. The recessed anti-glare LED spotlight fixture of claim 24, wherein the receiving support frame mounted to said receiving surface is a flanged round trim.

27. The recessed anti-glare LED spotlight fixture of claim 26, wherein the flanged round trim includes at least two spring clips for installation into said receiving surface.

28. The recessed anti-glare LED spotlight fixture of claim 24, wherein the receiving support frame mounted to said receiving surface is a flanged square trim.

29. The recessed anti-glare LED spotlight fixture of claim 28, wherein the flanged square trim includes at least two spring clips for installation into said receiving surface.

30. The recessed anti-glare LED spotlight fixture of claim 24, wherein the plurality of spring retaining assemblies includes at least three spring retaining assemblies.

31. The recessed anti-glare LED spotlight fixture of claim 24, wherein the receiving support frame mounted to said receiving surface can accommodate at least one LED light engine module.

32. The recessed anti-glare LED spotlight fixture of claim 31, wherein the receiving support frame mounted to said receiving surface is a spackle mud plate.

33. The recessed anti-glare LED spotlight fixture of claim 31, wherein the receiving support frame mounted to said receiving surface is a flanged round trim.

34. The recessed anti-glare LED spotlight fixture of claim 31, wherein the receiving support frame mounted to said receiving surface is a flanged square trim.

35. The recessed anti-glare LED spotlight fixture of claim 31, wherein each LED light engine module is in communication with a separate LED driver.

36. The recessed anti-glare LED spotlight fixture of claim 31, wherein each LED light engine module is in communication with a common LED driver.
